(19) United States
(12) Patent Application Publication
(10) Pub. No.: US 2022/0366810 A1
(43) Pub. Date: Nov. 17, 2022

(54) APPLICATION ONBOARDING TUTORIAL SYSTEM

(71) Applicant: Autodesk, Inc., San Rafael, CA (US)

(72) Inventors: Matthew Chan, Toronto (CA); Trevor Adams, Brossard (CA); Kourosh Dehghani, Toronto (CA); Simon Ouellet, Vaudreuil-Dorion (CA)

(73) Assignee: Autodesk, Inc., San Rafael, CA (US)

(21) Appl. No.: 17/743,710

(22) Filed: May 13, 2022

Related U.S. Application Data
(60) Provisional application No. 63/188,218, filed on May 13, 2021.

(51) Int. Cl. G09B 19/00; G06T 13/40; G06T 17/20; G06T 11/60; G06F 3/04842; G09B 5/02

(52) U.S. Cl. CPC G09B 19/003; G06T 13/40; G06T 17/20; G06T 11/60; G06F 3/04842; G09B 5/02; G06T 2213/08; G06T 2200/24

(57) ABSTRACT

A method and system provide the ability to operate a three-dimensional (3D) computer animation and visual effects application (3D application). An interactive tutorial is initialized to perform an operation in the 3D application. The operation consists of a series of two or more steps and is a 3D animation, modeling, or visual effect operation. A text instruction for performing a first step of the two or more steps is displayed. User input is received, and a determination is made regarding whether the input successfully completes the first step. If not successfully completed, the tutorial waits for additional user input. If the user input results in a successful completion of the first step, the tutorial repeats until additional steps of the operation are also completed.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 63/188,218, filed on May 13, 2021, with inventor(s) Matthew Chan, Trevor Adams, Kourosh Dehghani, and Simon Ouellet, entitled “Application Onboarding Tutorial System,” attorneys' docket number 30566.0601USP1.

### BACKGROUND OF THE INVENTION

### 1. Field of the Invention

The present invention relates generally to three-dimensional (3D) computer animation and visual effects software, and in particular, to a method, apparatus, system, framework, and article of manufacture for a tutorial system for onboarding new users.

### 2. Description of the Related Art

Three-dimensional (3D) computer animation and visual effects applications (3D application) can be complex and can have a steep learning curve. Studies have shown that with such 3D applications, there is a noteworthy percentage of users (e.g., prospects and/or existing customers) that churn (i.e., move to a competitor, have low use of the software, just evaluating, etc.). The cost of the 3D application, ease of use, and ease of learning are the biggest contributors of churn. Further, a majority of the users expect to learn how to use such 3D applications on their own compared to those that expect to learn by participating in formal training. In addition, users desire a minimal amount of time to learn how to use such 3D applications. In view of the above, it is desirable to have an on-boarding/first experience process that enables users to learn how to use such 3D applications (e.g., as a first experience with either the application or a feature of the application) while investing a minimum amount of time and effort. Prior art systems fail to provide such capabilities.

### SUMMARY OF THE INVENTION

One or more embodiments of the invention overcome the problems of the prior art by providing a state machine to build interactive tutorials for a 3D animation and visual effects application. The interactive tutorial provides a gamified mechanism for walking a user through the performance of a (3D animation, modeling, or visual effect) operation in the 3D application. Further, a 3D polygon avatar character immersed within the 3D application interacts with the user input to walk the user through the operation. The state machine controls the interactive tutorial and consists of daisy chained stage nodes that represent the steps of the tutorial and invoke scripts (or other computer code) that provide instructions to the user and control how the tutorial progresses. In addition, the state machine is exposed to the user such that it can be edited/modified to customize the tutorial. Further, by exposing the state machine capability, a user can create a new state machine to create a new tutorial.

### BRIEF DESCRIPTION OF THE DRAWINGS

Referring now to the drawings in which like reference numbers represent corresponding parts throughout:

FIG. 1 illustrates the Getting Started page with the ability to initialize a desired interactive tutorial in accordance with one or more embodiments of the invention;

FIGS. 2A-2B illustrate exemplary interactive tutorial screens in accordance with one or more embodiments of the invention;

FIGS. 3A and 3B illustrate exemplary graphical user interfaces for editing a node-based state machine in accordance with one or more embodiments of the invention;

FIG. 4 illustrates the details for attributes that can be used to chain together stage nodes in accordance with one or more embodiments of the invention;

FIG. 5 illustrates an exemplary state machine and corresponding images for a tutorial in accordance with one or more embodiments of the invention;

FIG. 6 illustrates the logical for operation a 3D computer animation and visual affects application (3D) application in accordance with one or more embodiments of the invention;

FIG. 7 is an exemplary hardware and software environment used to implement one or more embodiments of the invention; and

FIG. 8 schematically illustrates a typical distributed/cloud-based computer system in accordance with one or more embodiments of the invention.

### DETAILED DESCRIPTION OF THE INVENTION

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Interactive Tutorials User Experience

Embodiments of the invention provide a user experience that consists of a gamified learning experience via interactive learning tutorials. The learning experience is embedded into the application itself and led via an interactive character that is gender neutral, inviting, welcoming, and not intimidating. When starting the 3D application, the application prompts the user to determine whether the user is a new user or an experienced one. If new, the user is taken to a Getting Started page where an interactive tutorial is hosted. If experienced, the user may be brought to a different page and/or further queried to determine if the user would like to initialize the interactive learning tutorial (i.e., to enable the user to create their own in-app interactive experiences).

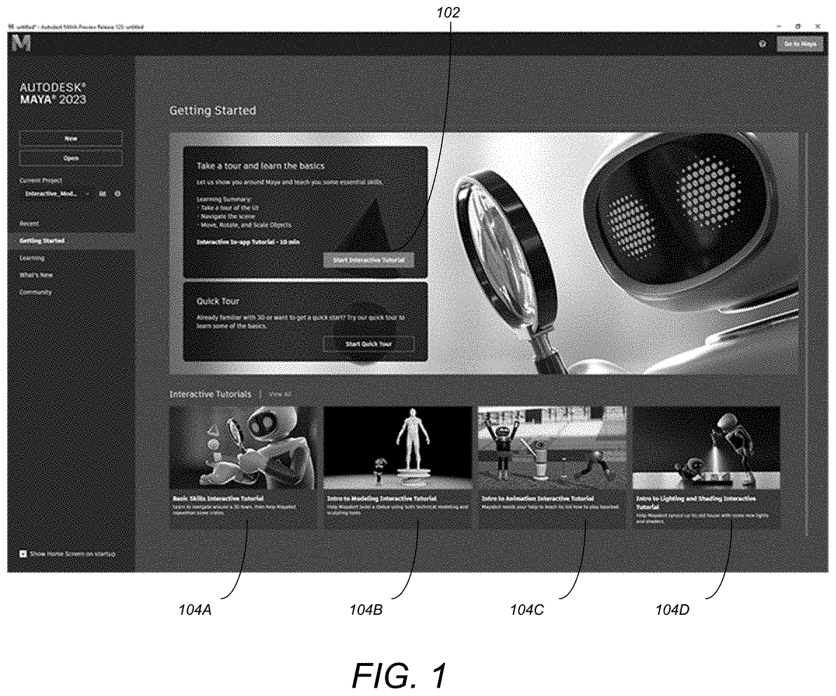

FIG. 1 illustrates the Getting Started page with the ability to initialize a desired interactive tutorial in accordance with one or more embodiments of the invention. By selecting button 102, the user begins the interactive tutorial to learn the basics of the 3D application (e.g., AUTODESK MAYA). Such a basics tutorial consists of a 10-minute interactive tutorial in one or more embodiments of the invention. The goal of such a basics tutorial is to teach the user general navigation of the 3D application interface within a short time period (e.g., 60-90 seconds). For example, the basics tutorial may provide the ability to help the user learn where to find and select transform tools and where their hotkeys are, where menu options are, how to navigate in a viewport (e.g., hot to move through the viewport and/or tumble the view), how to switch to a component mode, etc. Alternatively, the user can select one of the options 104A-104D to initiate a particular learning tutorial (e.g., to learn a specific task/process of 3D application) that has already been defined in the 3D application. Examples of such specific tasks include an introduction to modeling, an intro to animation, an intro to lighting and shading, etc.

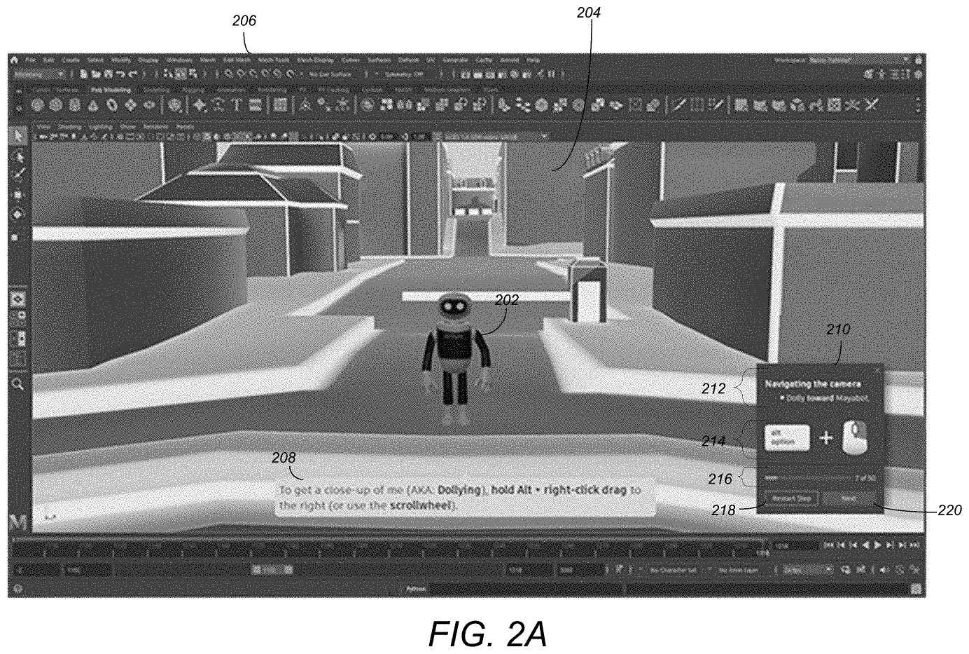

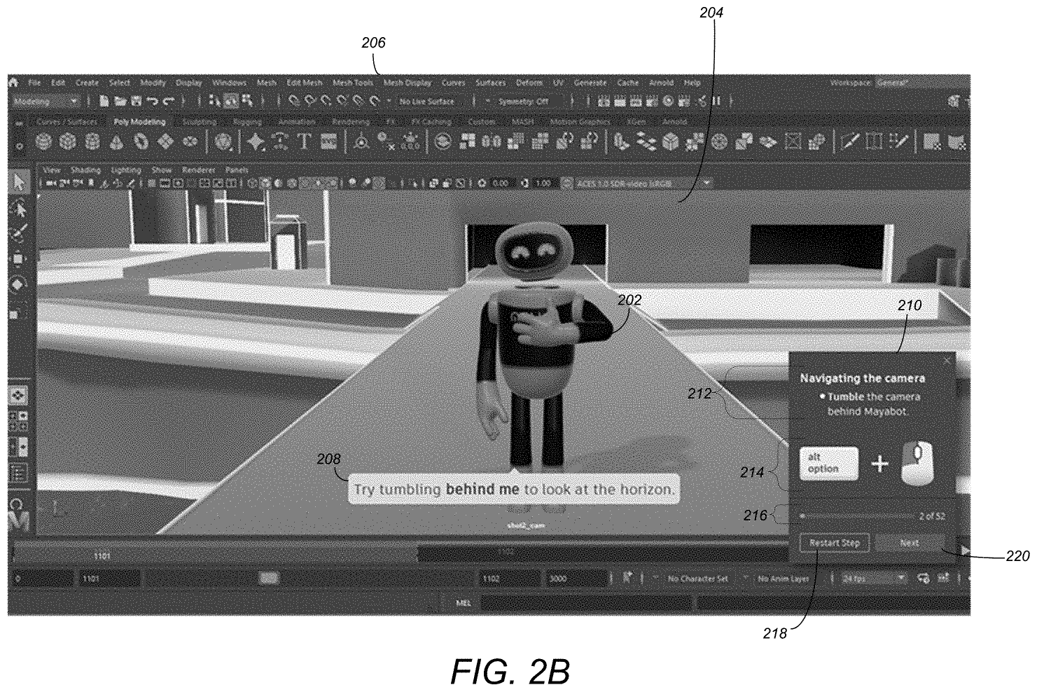

Once the interactive tutorial commences, an interactive tutorial screen is displayed where the user is introduced to a virtual instructor (e.g., a 3D polygon avatar character) that is immersed within the 3D application. FIGS. 2A-2B illustrate exemplary interactive tutorial screens in accordance with one or more embodiments of the invention. Both FIG. 2A and 2B illustrate the 3D avatar character 202 immersed within a model/scene 204 of the 3D application window 206. The avatar character 202 interacts with the user input to walk the user through the operation/subject of the interactive tutorial. In this regard, the interactive tutorial is for performing an operation in the 3D application that consists of a series of two or more steps and is an operation within the application itself—e.g., a 3D animation, modeling, or visual effects operation.

Text instructions for the tutorial may be displayed in two different areas—overlay bubble 208 and overlay dialog 210. The overlay bubble 208 is a word bubble-style overlay that includes text that describes how the user can perform a current step (i.e., of the multiple steps of the operation). In FIG. 2A, overlay bubble 208 includes the text “To get a close-up of me (AKA: Dollying), hold Alt+right-click drag to the right (or use the scroll wheel).” In FIG. 2B, the overlay bubble 208 includes the text “Try tumbling behind me to look at the horizon”.

The overlay dialog 210 is a dialog style overlay with an image or text that illustrates how and what input mechanisms the user can utilize to perform a current step. In FIG. 2A, the text 212 provides “Navigating the camera” and “Dolly toward Mayabot” (“Dolly” is the verb for moving/translating the camera through the 3D environment—e.g., closer to the avatar character 202 whose name is “Mayabot”). In FIG. 2B, the overlay dialog text 212 provides “Navigating the camera” and “Tumble the camera behind Mayabot”. In FIG. 2A, within overlay dialog 210, image(s) 214 illustrate that to perform the Dolly step, the user presses the “alt option” on the keyboard in conjunction with the right mouse button (e.g., via a picture of a computer mouse with the right mouse button highlighted/displayed in a distinguishable manner/color). In FIG. 2B, the image(s) 214 illustrate that to perform the tumbling step, the user presses the “alt option” on the keyboard in conjunction with the left mouse button. Overlay dialog 210 may also include a progress status indicator 216 that reflects how far the user has progressed in completing the steps in the operation. In FIG. 2A, the user has completed 7 of 50 steps. In FIG. 2B, the user has completed 2 of 52 steps. To restart a step, the user may select button 218 and to proceed to the next step the user selects “Next” button 220. Further, in one or more embodiments, the indicated action must be performed in order to proceed to the next step in the sequence. In other words, the system recognizes and waits for particular user input as part of the interactive tutorial.

Via the interactive tutorial, the user walks through the steps of an operation in the application itself in an interactive fully immersive manner while actually using the application (i.e., in contrast to a static video playback and/or walkthrough of static screen shots where the user is not actually performing an operation that the application was designed for (e.g., a 3D animation operation, modeling operation, visual effect operation, etc.). Thus, embodiments of the invention provide a system where the application itself teaches users how to use the application interactively in a gamified way while recognizing user inputs and successful passing of the steps required to move onto the next step.

### State Machine Control of Interactive Tutorial

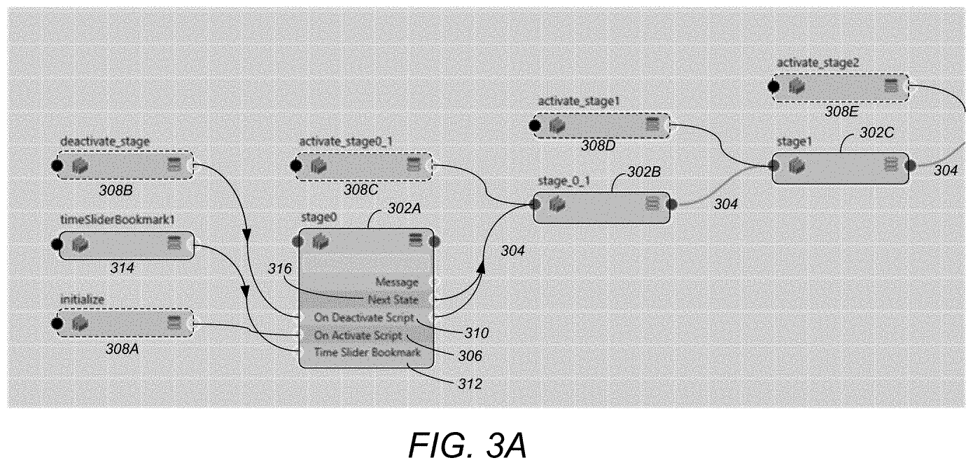

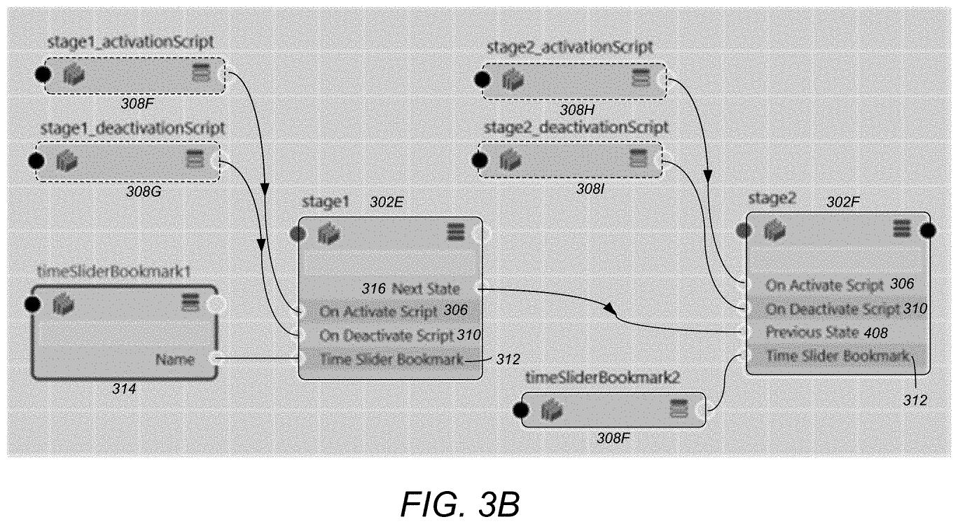

In one or more embodiments of the invention, the interactive tutorial is controlled using a node-based state machine. FIGS. 3A and 3B illustrate exemplary graphical user interfaces for editing a node-based state machine in accordance with one or more embodiments of the invention. The state machine consists of multiple stage nodes 302 (i.e., stage nodes 302A-302F collectively referred to as stage nodes 302) that are daisy chained together via connections 304. The connections 304 reflect dependencies between the multiple stage nodes 302 that are connected via the daisy chaining. Each of the multiple stage nodes 302 corresponds to a step of the interactive tutorial. Further, dependent stage nodes (e.g., stage nodes 302B, 302C, and 302F) are dependent upon parent stage nodes (e.g., stage nodes 302A, 302B, and 302E respectively) such that steps of dependent stage nodes (e.g., stage nodes 302B, 302C, and 302F) begin when the steps of the respective parent stage node (e.g., stage nodes 302A, 302B, and 302E respectively) end/completes. A set of instructions are defined for each stage node 302 that determine how the 3D application behaves upon activation of that stage node 302.

Stage nodes 302A, 302E and 302F have been expanded to display the attributes that have been configured for that stage node. The “On Activate Script” attribute 306 has a connection to a script node (e.g., script nodes 308A, 308F, and 308H). Each stage node 302 is connected via an “On Activate Script” attribute 306 to a script node (e.g., either an activation or deactivation script node). Script nodes 308 are where the bulk of each stage happens. The script node 308 may consist of a script/code written in a computer coding language (e.g., PYTHON, C++, BASIC, etc.). Essentially, the script node 308 automates operations/steps of the 3D application.

The “On Deactivate Script” attribute 310 is utilized to connect a script node (e.g., script nodes 308B, 308G, and 308I) to clean up after a stage once it's finished. In this regard, it is good practice to try and keep stage logic self-contained so that it's easy to move the stage 302 around or insert/delete a stage 302 as needed. In FIG. 3A, stage0_1 302B was inserted between stage0 302A and stage1 302C at some point during development. It can also be handy to design a universal deactivate script 308B that can be used by all stage nodes 302, allowing the developer to simply connect all the “On Deactivate Script” attributes 310 down the chain for readability.

The “Time Slider Bookmark” attribute 312 may be used for setting up animations at the beginning of a stage, but also for changing the state of a scene between one stage to another. In FIGS. 3A and 3B, the Time Slider Bookmark attribute 312 is connected to bookmark node 314. In an exemplary use of a bookmark, the active camera can be keyframed at the start of the bookmark to have the camera jump to a different spot in the scene at the beginning of the stage. Alternatively, an object's visibility can be keyframed to have it appear during one stage but not another.

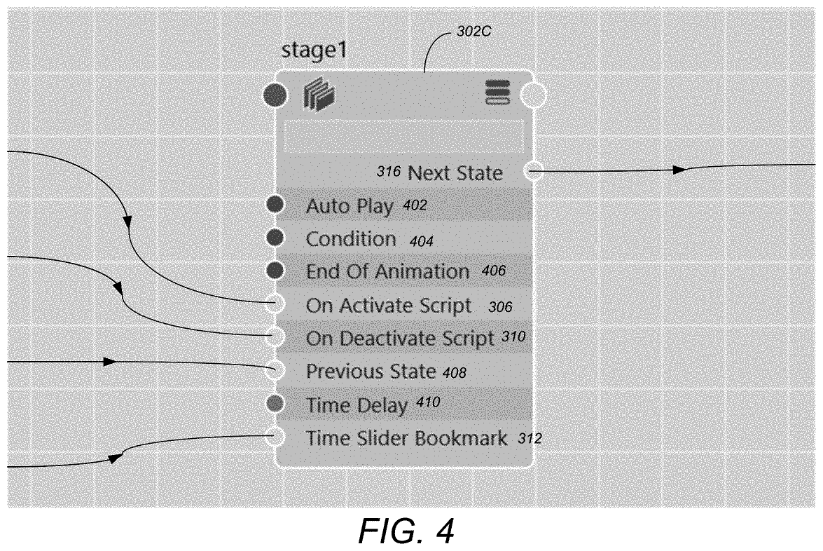

The progression of stages based on the daisy chained stage nodes 302 may be defined using the node based state machine. Depending on the goal of a stage, the way it progresses to the next stage may differ. In this regard, stage nodes 302 may be chained together to execute multiple scripts in sequence according to a set of rules. These are useful for creating interactive experiences such as the tutorials of embodiments of the invention. FIG. 4 illustrates the details for attributes that can be used to chain together stage nodes in accordance with one or more embodiments of the invention. Referring to FIGS. 3A, 3B and 4, attributes for stage nodes 302 may include:
(i) Autoplay 402— turn this on to force playback of the current playback range when the stage is activated.
(ii) Condition 404— turn this on to deactivate the current stage and activate the next stage (determined by Next State 316). In other words, condition attribute 404 is used trigger the next stage on any sort of event, such as when the user clicks a button on a custom window or other UI widget, or when they fulfill some sort of condition (e.g., the moving an object into a specific spot, or opening specific editor). In the latter case, the command may need to be embedded inside a script job in order to listen for those events.
(iii) End of Animation 406— turn this on to deactivate the current stage and activate the next stage (determined by the Next State 316) when the Time Slider reaches the end of the current playback range. The End of Animation attribute 406 may be used for stages that are simply demonstrating something to the user. The next stage 316 will activate automatically once the Time Slider is played to the end.
(iv) On Activate Script 306— the script that is executed when the stage is activated.
(v) On Deactivate Script 310— the script that is executed the stage is deactivated.
(vi) Previous State 408— the stage node 302 preceding the current stage.
(vii) Next State 316— the stage node 302 succeeding the current stage.
(viii) Time Delay 410— A delay (in seconds) before the current stage automatically deactivates and moves on to the next stage. In this regard, setting a non-zero delay value may be used to give a stage a time limit before automatically progressing to the next stage (e.g., useful to give the user a finite time to explore before moving on).
(ix) Time Slider Bookmark 312— the Time Slider bookmark to frame when the stage is activated.

In addition, various source code/scripts may be used to display the 2D text or images on the user interface such as that illustrated in FIGS. 2A-2B. Such 2D text or images may be the best way to give instructions and hints to the user. More specifically, overlay source code may be defined in script nodes 308. Such script nodes 308 may include definitions for an overlay bubble, an overlay dialog, and/or a controller. In this regard, most of the work for a stage happens in its connected script nodes 308. In FIG. 3A, these are typically named ‘activate_stage’ (308C, 308D, 308E) or ‘deactivate_stage’ (308B). There are also a number of helper scripts that are not connected to stages, but are often called by them to perform some common tasks. Some examples include:
overlayBubble: Handles drawing word bubble-style overlays (e.g., overlay bubble 208 of FIGS. 2A and 2B) on-screen.
overlayDialog: Handles drawing dialog box-style overlays (e.g., overlay dialog 210 of FIGS. 2A and 2B) on-screen. Unlike bubbles, these can be moved and closed.
clearOverlays: Delete all bubble-style overlays.
clearDialogs: Delete all dialog-style overlays.
populateText: Contains a dictionary of all the text for the tutorial which can be referenced via stage name.
updateController: Refreshes the text and visibility of the controller.

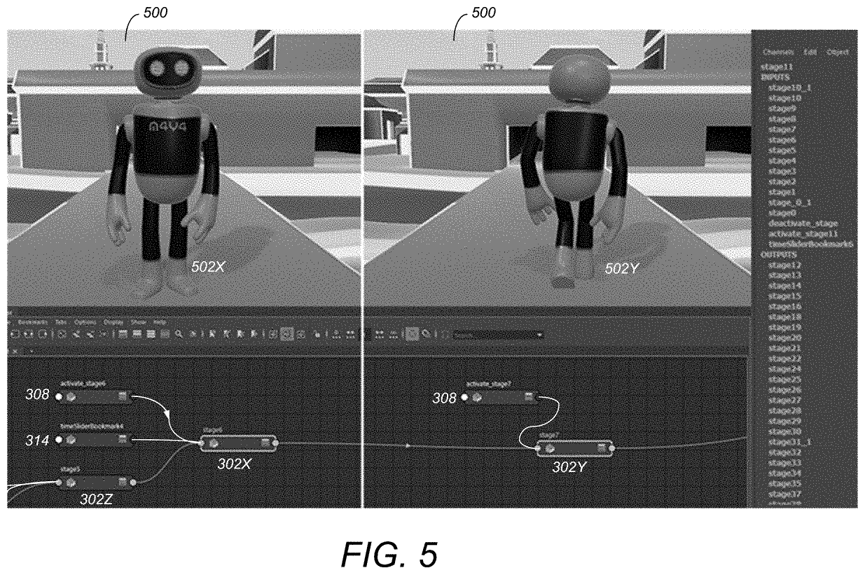

FIG. 5 illustrates an exemplary state machine and corresponding images for a tutorial in accordance with one or more embodiments of the invention. As illustrated, script nodes 308 can be executed sequentially using a state machine, which consists of several stage nodes 302 that are daisy chained together. The nodes 302 and 308 allow you to easily insert, remove, or rearrange the order of execution of the scripts 308. In FIG. 5, the image of the avatar 502X reflects the actions being performed in stage node 302X, while the image off avatar 502Y reflects the actions being performed in stage node 302Y (e.g., the user has navigated or is moving forward in the model scene 500).

### Logical Flow

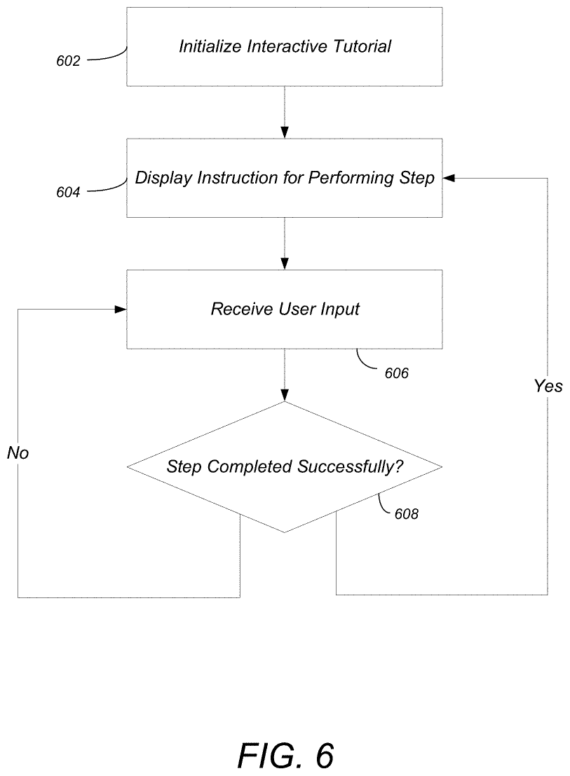

FIG. 6 illustrates the logical for operation a 3D computer animation and visual affects application (3D) application in accordance with one or more embodiments of the invention.

At step 602, an interactive tutorial for performing an operation in the 3D application is initialized. The operation consists of a series of two or more steps and is a 3D animation, modeling, or visual effect operation.

At step 604, an instruction for performing a first step of the two or more steps is displayed in the 3D application. The instruction consists of text. In one or more embodiments, the instruction is an overlay bubble that is a word bubble-style overlay that includes the text. Further, the text in the overlay bubble describes how the user can perform a current step of the two or more steps. Alternatively, or in addition, the instruction may be an overlay dialog that is a dialog box style overlay. Such an overlay dialog is an image or text that illustrates how and what input mechanisms the user can utilize to perform a current step of the two or more steps. Further, the overlay dialog may include a progress status indicator reflecting how far the user has progressed in completing the two or more steps in the operation.

At step 606, input from a user is received into the 3D application.

At step 608, a determination is made regarding whether the input successfully completes/comprises the first step. The determination can be made based on an exact completion of the step or a range. For example, if the step consists of moving to a certain view or camera frustrum within a model, once the user has reached within a certain threshold range of that view/location, the step may be successfully completed. Alternatively, the user may be required to move to an exact view or camera frustrum. The range may also determine if a certain percentage of the step has been completed (e.g., if 6% of the particular steps have been completed).

If the input does not successfully comprise the first step, the system may wait for additional user input to further complete the step. Alternatively, if the input successfully comprises the first step, steps 604-608 are repeated for additional steps of the operation (i.e., until the operation has been completed).

Steps 602-608 may also include displaying a 3D polygon avatar character immersed within the 3D application. Such a 3D polygon avatar character interacts with the user input to walk the user through the operation.

Further to the above, the interactive tutorial initialized in step 602 (i.e., and the performance of steps 604-608) may be controlled using a node-based state machine. Such a node-based state machine consists of multiple stage nodes that are daisy chained together via on one or more connections. The connections reflect dependencies between the multiple stage nodes that are connected via the daisy chaining. Each of the multiple stage nodes corresponds to one of the two or more steps. In addition, a second stage node of the multiple stage nodes is dependent upon a completion of a first stage node that the second stage node is connected to such that the second stage node begins when the first stage node ends. A set of instructions are defined (e.g., via a computer coding language) for the second stage node and the set of instructions determine how the 3D application behaves upon activation of the second stage node.

Within the node-based state machine, an additional set of instructions also be defined for the second stage node. The additional set of instructions determines how the 3D application behaves upon deactivation of the second stage node.

Further to the above, the node-based state machine may be exposed to the user via a graph in a graphical user interface. Each of the multiple stage nodes is illustrated in the graph as a node, and the one or more connections between the multiple stage nodes are illustrated as lines. The graph can be edited (via user input into the graph) (e.g., by editing/moving one or more of the multiple stage nodes or one or more connections) such that the editing/moving affects the sequence of the interactive tutorial.

In addition, as part of the interactive tutorial (and via the node-based state machine), a pre-defined animation (e.g., a timeslider bookmark) may be triggered based on an initiation of the first step. Such an animation is intended to show/demonstrate to the user how a step is performed and/or the potential operations of the 3D application.

### Hardware Environment

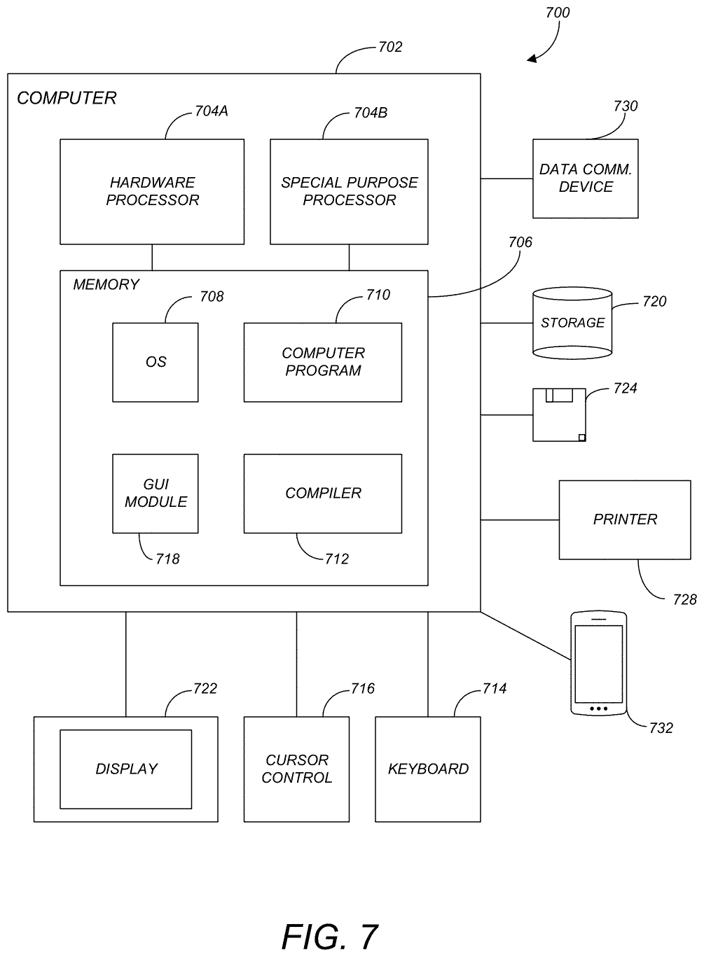

FIG. 7 is an exemplary hardware and software environment 700 (referred to as a computer-implemented system and/or computer-implemented method) used to implement one or more embodiments of the invention. The hardware and software environment includes a computer 702 and may include peripherals. Computer 702 may be a user/client computer, server computer, or may be a database computer. The computer 702 comprises a hardware processor 704A and/or a special purpose hardware processor 704B (hereinafter alternatively collectively referred to as processor 704) and a memory 706, such as random access memory (RAM). The computer 702 may be coupled to, and/or integrated with, other devices, including input/output (I/O) devices such as a keyboard 714, a cursor control device 716 (e.g., a mouse, a pointing device, pen and tablet, touch screen, multi-touch device, etc.) and a printer 728. In one or more embodiments, computer 702 may be coupled to, or may comprise, a portable or media viewing/listening device 732 (e.g., an MP3 player, IPOD, NOOK, portable digital video player, cellular device, personal digital assistant, etc.). In yet another embodiment, the computer 702 may comprise a multi-touch device, mobile phone, gaming system, internet enabled television, television set top box, or other internet enabled device executing on various platforms and operating systems.

In one embodiment, the computer 702 operates by the hardware processor 704A performing instructions defined by the computer program 710 (e.g., a computer-aided design [CAD] application) under control of an operating system 708. The computer program 710 and/or the operating system 708 may be stored in the memory 706 and may interface with the user and/or other devices to accept input and commands and, based on such input and commands and the instructions defined by the computer program 710 and operating system 708, to provide output and results.

Output/results may be presented on the display 722 or provided to another device for presentation or further processing or action. In one embodiment, the display 722 comprises a liquid crystal display (LCD) having a plurality of separately addressable liquid crystals. Alternatively, the display 722 may comprise a light emitting diode (LED) display having clusters of red, green and blue diodes driven together to form full-color pixels. Each liquid crystal or pixel of the display 722 changes to an opaque or translucent state to form a part of the image on the display in response to the data or information generated by the processor 704 from the application of the instructions of the computer program 710 and/or operating system 708 to the input and commands. The image may be provided through a graphical user interface (GUI) module 718. Although the GUI module 718 is depicted as a separate module, the instructions performing the GUI functions can be resident or distributed in the operating system 708, the computer program 710, or implemented with special purpose memory and processors.

In one or more embodiments, the display 722 is integrated with/into the computer 702 and comprises a multi-touch device having a touch sensing surface (e.g., track pad or touch screen) with the ability to recognize the presence of two or more points of contact with the surface. Examples of multi-touch devices include mobile devices (e.g., IPHONE, NEXUS S, DROID devices, etc.), tablet computers (e.g., IPAD, HP TOUCHPAD, SURFACE Devices, etc.), portable/handheld game/music/video player/console devices (e.g., IPOD TOUCH, MP3 players, NINTENDO SWITCH, PLAYSTATION PORTABLE, etc.), touch tables, and walls (e.g., where an image is projected through acrylic and/or glass, and the image is then backlit with LEDs).

Some or all of the operations/procedures performed by the computer 702 according to the computer program 710 instructions may be implemented in a special purpose processor 704B. In this embodiment, some or all of the computer program 710 instructions may be implemented via firmware instructions stored in a read only memory (ROM), a programmable read only memory (PROM) or flash memory within the special purpose processor 704B or in memory 706. The special purpose processor 704B may also be hardwired through circuit design to perform some or all of the operations/procedures to implement the present invention. Further, the special purpose processor 704B may be a hybrid processor, which includes dedicated circuitry for performing a subset of functions, and other circuits for performing more general functions such as responding to computer program 710 instructions. In one embodiment, the special purpose processor 704B is an application specific integrated circuit (ASIC).

The computer 702 may also implement a compiler 712 that allows an application or computer program 710 written in a programming language such as C, C++, Assembly, SQL, PYTHON, PROLOG, MATLAB, RUBY, RAILS, HASKELL, or other language to be translated into processor 704 readable code. Alternatively, the compiler 712 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 710 accesses and manipulates data accepted from I/O devices and stored in the memory 706 of the computer 702 using the relationships and logic that were generated using the compiler 712.

The computer 702 also optionally comprises an external communication device such as a modem, satellite link, Ethernet card, or other device for accepting input from, and providing output to, other computers 702.

In one embodiment, instructions implementing the operating system 708, the computer program 710, and the compiler 712 are tangibly embodied in a non-transitory computer-readable medium, e.g., data storage device 720, which could include one or more fixed or removable data storage devices, such as a zip drive, floppy disc drive 724, hard drive, CD-ROM drive, tape drive, etc. Further, the operating system 708 and the computer program 710 are comprised of computer program 710 instructions which, when accessed, read and executed by the computer 702, cause the computer 702 to perform the steps necessary to implement and/or use the present invention or to load the program of instructions into a memory 706, thus creating a special purpose data structure causing the computer 702 to operate as a specially programmed computer executing the method steps described herein. Computer program 710 and/or operating instructions may also be tangibly embodied in memory 706 and/or data communications devices 730, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 702.

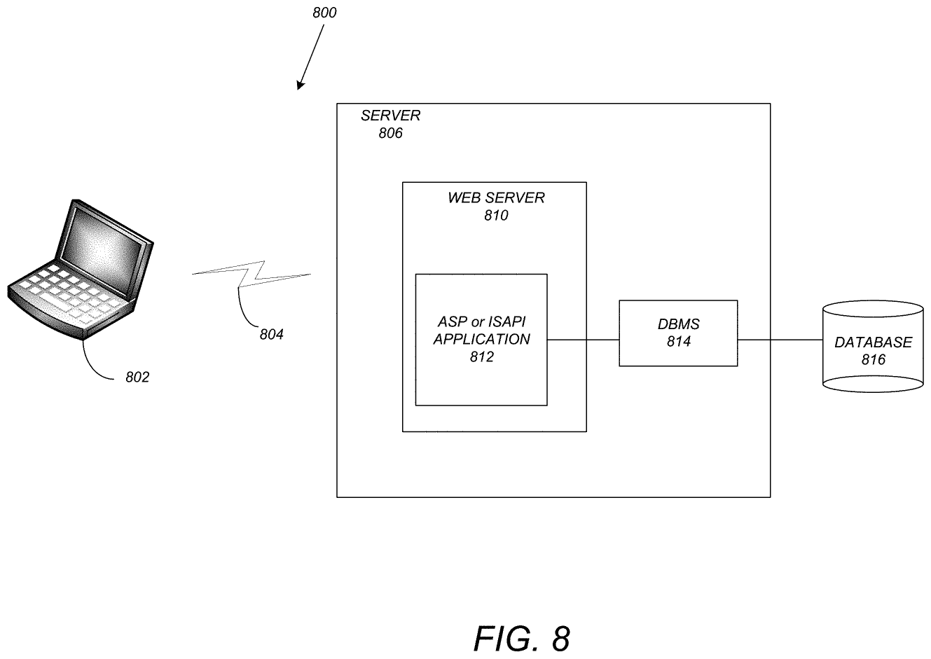

FIG. 8 schematically illustrates a typical distributed/cloud-based computer system 800 using a network 804 to connect client computers 802 to server computers 806. A typical combination of resources may include a network 804 comprising the Internet, LANs (local area networks), WANs (wide area networks), SNA (systems network architecture) networks, or the like, clients 802 that are personal computers or workstations (as set forth in FIG. 7), and servers 806 that are personal computers, workstations, minicomputers, or mainframes (as set forth in FIG. 7). However, it may be noted that different networks such as a cellular network (e.g., GSM [global system for mobile communications] or otherwise), a satellite-based network, or any other type of network may be used to connect clients 802 and servers 806 in accordance with embodiments of the invention.

A network 804 such as the Internet connects clients 802 to server computers 806. Network 804 may utilize ethernet, coaxial cable, wireless communications, radio frequency (RF), etc. to connect and provide the communication between clients 802 and servers 806. Further, in a cloud-based computing system, resources (e.g., storage, processors, applications, memory, infrastructure, etc.) in clients 802 and server computers 806 may be shared by clients 802, server computers 806, and users across one or more networks. Resources may be shared by multiple users and can be dynamically reallocated per demand. In this regard, cloud computing may be referred to as a model for enabling access to a shared pool of configurable computing resources.

Clients 802 may execute a client application or web browser and communicate with server computers 806 executing web servers 810. Such a web browser is typically a program such as MICROSOFT INTERNET EXPLORER/EDGE, MOZILLA FIREFOX, OPERA, APPLE SAFARI, GOOGLE CHROME, etc. Further, the software executing on clients 802 may be downloaded from server computer 806 to client computers 802 and installed as a plug-in or ACTIVEX control of a web browser. Accordingly, clients 802 may utilize ACTIVEX components/component object model (COM) or distributed COM (DCOM) components to provide a user interface on a display of client 802. The web server 810 is typically a program such as MICROSOFT'S INTERNET INFORMATION SERVER.

Web server 810 may host an Active Server Page (ASP) or Internet Server Application Programming Interface (ISAPI) application 812, which may be executing scripts. The scripts invoke objects that execute business logic (referred to as business objects). The business objects then manipulate data in database 816 through a database management system (DBMS) 814. Alternatively, database 816 may be part of, or connected directly to, client 802 instead of communicating/obtaining the information from database 816 across network 804. When a developer encapsulates the business functionality into objects, the system may be referred to as a component object model (COM) system. Accordingly, the scripts executing on web server 810 (and/or application 812) invoke COM objects that implement the business logic. Further, server 806 may utilize MICROSOFT'S TRANSACTION SERVER (MTS) to access required data stored in database 816 via an interface such as ADO (Active Data Objects), OLE DB (Object Linking and Embedding DataBase), or ODBC (Open DataBase Connectivity).

Generally, these components 800-816 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 802 and 806 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 802 and 806. Embodiments of the invention are implemented as a software/CAD application on a client 802 or server computer 806. Further, as described above, the client 802 or server computer 806 may comprise a thin client device or a portable device that has a multi-touch-based display.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for operating a three-dimensional (3D) computer animation and visual effects application (3D application), comprising:
(a) initializing an interactive tutorial for performing an operation in the 3D application, wherein the operation comprises:
(i) a series of two or more steps; and
(ii) a 3D animation, modeling, or visual effect operation;
(b) displaying, in the 3D application, an instruction for performing a first step of the two or more steps, wherein the instruction comprises text;
(c) receiving, into the 3D application, input from a user;
(d) determining, in the 3D application, whether the input successfully comprises the first step;
(e) if the input does not successfully comprise the first step, waiting for additional user input; and
(f) if the input successfully comprises the first step, repeating (b)-(f) for additional steps of the operation.

2. The computer-implemented method of claim 1, further comprising:
displaying a 3D polygon avatar character immersed within the 3D application, wherein:
the 3D polygon avatar character interacts with the user input to walk the user through the operation.

3. The computer-implemented method of claim 1, wherein the instruction comprises:
an overlay bubble comprising a word bubble-style overlay that includes the text;
the text describes how the user can perform a current step of the two or more steps.

4. The computer-implemented method of claim 1, wherein:
the instruction comprises an overlay dialog comprising a dialog box style overlay;
the overlay dialog comprises an image or text that illustrates how and what input mechanisms the user can utilize to perform a current step of the two or more steps; and
the overlay dialog comprises a progress status indicator reflecting how far the user has progressed in completing the two or more steps in the operation.

5. The computer-implemented method of claim 1, further comprising:
controlling the interactive tutorial using a node-based state machine, wherein:
the node-based state machine comprises multiple stage nodes that are daisy chained together via on one or more connections;
the connections reflect dependencies between the multiple stage nodes that are connected via the daisy chaining;
each of the multiple stage nodes corresponds to one of the two or more steps;
a second stage node of the multiple stage nodes is dependent upon a completion of a first stage node that the second stage node is connected to such that the second stage node begins when the first stage node ends;
a set of instructions are defined for the second stage node; and
the set of instructions determine how the 3D application behaves upon activation of the second stage node.

6. The computer-implemented method of claim 5, wherein:
an additional set of instructions are defined for the second stage node; and
the additional set of instructions determines how the 3D application behaves upon deactivation of the second stage node.

7. The computer-implemented method of claim 5, wherein:
the set of instructions is defined using a computer coding language.

8. The computer-implemented method of claim 5, further comprising:
exposing the node-based state machine to the user via a graph in a graphical user interface, wherein:
each of the multiple stage nodes is illustrated in the graph as a node;
the one or more connections between the multiple stage nodes are illustrated as lines;
editing, via user input into the graph, one or more of the multiple stage nodes or one or more connections, wherein the editing affects the sequence of the interactive tutorial.

9. The computer-implemented method of claim 5, further comprising:
triggering a pre-defined animation based on an initiation of the first step.

10. A computer-implemented system for operating a three-dimensional (3D) computer animation and visual effects application (3D application), comprising:
(a) a computer having a memory;
(b) a processor executing on the computer;
(c) the memory storing a set of instructions, wherein the set of instructions, when executed by the processor cause the processor to perform procedures comprising:
initializing an interactive tutorial for performing an operation in the 3D application, wherein the operation comprises:
(1) a series of two or more steps; and
(2) a 3D animation, modeling, or visual effect operation;
(ii) displaying, in the 3D application, an instruction for performing a first step of the two or more steps, wherein the instruction comprises text;
(iii) receiving, into the 3D application, input from a user;
(iv) determining, in the 3D application, whether the input successfully comprises the first step;
(v) if the input does not successfully comprise the first step, waiting for additional user input; and
(vi) if the input successfully comprises the first step, repeating (ii)-(vi) for additional steps of the operation.

11. The computer-implemented system of claim 10, wherein the procedures further comprise:
displaying a 3D polygon avatar character immersed within the 3D application, wherein:
the 3D polygon avatar character interacts with the user input to walk the user through the operation.

12. The computer-implemented system of claim 10, wherein the instruction comprises:
an overlay bubble comprising a word bubble-style overlay that includes the text;
the text describes how the user can perform a current step of the two or more steps.

13. The computer-implemented system of claim 10, wherein:
the instruction comprises an overlay dialog comprising a dialog box style overlay;
the overlay dialog comprises an image or text that illustrates how and what input mechanisms the user can utilize to perform a current step of the two or more steps; and
the overlay dialog comprises a progress status indicator reflecting how far the user has progressed in completing the two or more steps in the operation.

14. The computer-implemented system of claim 10, wherein the procedures further comprise:
controlling the interactive tutorial using a node-based state machine, wherein:
the node-based state machine comprises multiple stage nodes that are daisy chained together via on one or more connections;
the connections reflect dependencies between the multiple stage nodes that are connected via the daisy chaining;
each of the multiple stage nodes corresponds to one of the two or more steps;
a second stage node of the multiple stage nodes is dependent upon a completion of a first stage node that the second stage node is connected to such that the second stage node begins when the first stage node ends;
a set of instructions are defined for the second stage node; and
the set of instructions determine how the 3D application behaves upon activation of the second stage node.

15. The computer-implemented system of claim 14, wherein:
an additional set of instructions are defined for the second stage node; and
the additional set of instructions determines how the 3D application behaves upon deactivation of the second stage node.

16. The computer-implemented system of claim 14, wherein:
the set of instructions is defined using a computer coding language.

17. The computer-implemented system of claim 14, wherein the procedures further comprise:
exposing the node-based state machine to the user via a graph in a graphical user interface, wherein:
each of the multiple stage nodes is illustrated in the graph as a node;
the one or more connections between the multiple stage nodes are illustrated as lines;
editing, via user input into the graph, one or more of the multiple stage nodes or one or more connections, wherein the editing affects the sequence of the interactive tutorial.

18. The computer-implemented system of claim 14, wherein the procedures further comprise:
triggering a pre-defined animation based on an initiation of the first step.
